(19) United States
(12) Patent Application Publication
(10) Pub. No.: US 2011/0200078 A1
(43) Pub. Date: Aug. 18, 2011

(54) COMMUNICATION APPARATUS, COMMUNICATION METHOD, AND PROGRAM PRODUCT

(75) Inventor: Yoshiteru TAMURA, Nagoya (JP)

(73) Assignee: BUFFALO INC., Nagoya-shi (JP)

(21) Appl. No.: 13/029,029

(22) Filed: Feb. 16, 2011

(30) Foreign Application Priority Data
Feb. 16, 2010 (JP) 2010-31336

(51) Int. Cl. H04B 1/38

(52) U.S. Cl. 375/222

(57) ABSTRACT

Disclosed is a communication apparatus, comprising: a connector which can be connected with modems that have different communication-related characteristics and achieve wireless communication with an external network; a selector for selecting one of the modems that are connected with the connector in a communicable manner, in accordance with a preset communication condition, for communication with the external network in a new session; and a communicator for achieving wireless communication with the external network in the new session by using the selected modem.

### CROSS REFERENCE TO RELATED APPLICATION

The present application claims priority from Japanese application P2010-31336A filed on Feb. 16, 2010, the content of which is hereby incorporated by reference into this application.

### BACKGROUND

1. Field of the Invention

The present invention relates to a technique for communicating wirelessly with an external network.

2. Description of the Related Art

In recent years, mobile communication networks accessible to the Internet have been provided by various carriers (mobile network operators). Connection of a data communication card to an electronic device, such as a personal computer or a router allows the user anywhere to have access to an external network, such as the Internet. Such plural data communication cards may be connected simultaneously to one electronic device. However, if such plural data communication cards are connected to the electronic device in such a manner that they are all ready for communication, the electronic device must select one of the cards as required each time the electronic device needs to communicate with the external network. This requirement is not restricted to communication using such data communication cards but is common to any communication system in which wireless communication is achieved by using plural communication means.

### SUMMARY

The gist of this invention is to achieve wireless communication in which one of plural wireless communication means having different communication characteristics is automatically selected depending on required conditions.

A first aspect of the present invention is directed to a communication apparatus including a connector connectable with plural modems that have different communication-related characteristics and are used to wirelessly communicate with an external network. The communication apparatus also includes a selector for selecting one of the modems on the basis of a preset communication condition when the communication apparatus communicates with the external network in a new session, with the modems connected ready for communication with the connector. The communication apparatus further includes a communicator for communicating wirelessly with the external network in the new session by using the selected modem.

The communication apparatus according to this aspect of the invention selects one of the modems connected ready for communication with the external network and having different communication characteristics, on the basis of a preset communication condition when the communication apparatus communicates with the external network in a new session, and communicates with the external network by using the selected modem in the new session. The communication apparatus of this design enables one modem to be automatically selected among the modems having different communication characteristics, based on the preset communication condition, and achieve wireless communication. This design does not require the user to perform the operation of selecting a modem used for wireless communication each time, thus enhancing usability.

In one application of the communication apparatus, the preset communication condition includes selecting one of the modems, based on a rule defined according to information included in a packet that is sent by the communicator to the external network.

The communication apparatus of this application automatically selects the modem, based on the information included in a packet that is sent to the external network. This design allows for the selection of a modem having a favorable communication condition suitable for the nature of communication derived from various data included in the packet.

In one embodiment of the present invention, the communication apparatus further includes a determiner for determining the status of communication load with regard to each of the modems. The preset communication condition includes selecting the modems so that the communication load may not concentrate on a particular modem.

The communication apparatus of this design determines the status of the communication load with regard to each of the modems and selects one of the modems to assure the distribution of the communication load to the respective modems. This design allows for selection of a suitable modem to enhance the overall communication speed of the communication apparatus.

In another application of the communication apparatus of this embodiment, the determiner detects the inbound communication speed and the outbound communication speed in the communication of the communicator with the external network and determines the status of the communication load, based on the obtained inbound or outbound communication speed. The determiner varies the degree of contribution of the inbound and outbound communication speeds to the determination of the status of the communication load according to the information included in the packet with which the communication apparatus communicates with the external network.

The communication apparatus of this design varies the degree of contribution of the inbound and outbound communication speeds to the determination of the status of the communication load according to the information included in the packet with which the communication apparatus communicates with the external network. This design enables the status of the communication load to be determined according to one of the actual communication directions, i.e., inbound and outbound directions, thus enhancing the accuracy of the determination.

In another embodiment of the present invention, the communication apparatus further includes a detector for detecting the field intensity of radio waves sent from the base station of a carrier corresponding to each of the modems. The preset communication condition includes the selection of a modem receiving radio waves having a relatively high field intensity.

The communication apparatus of this embodiment detects the field intensities of radio waves sent from the respective base stations and automatically selects a modem receiving radio waves having a relatively high field intensity. This design allows for selection of a suitable modem for stable communication.

In another application of the communication apparatus, the preset communication condition is one communication condition selected from at least two different communication conditions. When the expected traffic of communication with the external network in one session is figured out, the selector changes the communication condition according to the expected communication traffic and reselects one of the modems.

The communication apparatus of this design changes the communication condition according to the expected traffic of communication with the external network in one session and reselects one modem. This design enables one of the modems to be flexibly selected according to the communication traffic and achieve communication suitable for the expected communication traffic, thus enhancing usability.

The technique of the invention is not restricted to the communication apparatus having any of the configurations as described above, but may be embodied as a variety of applications such as, for example, a communication method and a computer program product.

### BRIEF DESCRIPTION OF THE DRAWINGS

FIG. 1 illustrates one application of a router as one embodiment of the communication apparatus according to the present invention;

FIG. 2 shows in block diagram the general structure of the router;

FIG. 3 is the flowchart of a connection selection process performed in the router;

FIG. 4 is the flowchart of a modem selection process according to rule R1;

FIG. 5 is the flowchart of a modem selection process according to rule R2;

FIG. 6 is the flowchart of a modem selection process according to rule R3;

FIG. 7 is the flowchart of a modem selection process performed in a second embodiment of the invention; and

FIG. 8 is the flowchart of a connection change process performed in a router in a third embodiment of the invention.

### DETAILED DESCRIPTION OF THE EMBODIMENTS

The present invention is described in detail below by way of embodiment with reference to the accompanying drawings.

### A. First Embodiment

### A-1. General Structure of Router 20

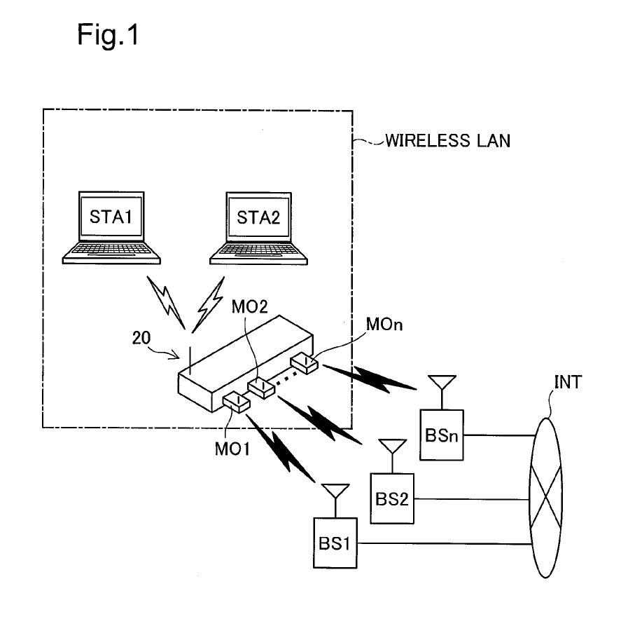

FIG. 1 shows one application of a router 20 as a first embodiment of the communication apparatus according to the present invention. The router 20 is a router device that can function also as an access point for a wireless LAN. In this embodiment, as shown in FIG. 1, the router 20 and terminals STA1 and STA2 constitute a wireless LAN, which is in conformity with IEEE 802.11 standard. The router 20 and the terminals STA1 and STA2 may alternatively be interconnected by cables. The router 20 can be connected with a single terminal device or more than two terminal devices.

N data communication cards MO1 to MOn are connected to the router 20, where N denotes an integer not less than 2. The respective data communication cards MO1 to MOn have built-in modems for performing wireless communication by using mobile communication networks provided by carriers and the built-in modems have different communication characteristics. Here the ‘communication characteristics’ means a variety of communication-related characteristics, such as the types of carrier, the types of mobile communication network, communication speeds depending on the types of the carrier and the mobile communication network and on the performances of the modems, and communication charge systems. In this embodiment, the respective data communication cards MO1 to MOn are dedicated to different carriers. The router 20 can be linked to the Internet INT via base stations BS1 to BSn of the carriers corresponding to the respective data communication cards MO1 to MOn over the wireless channels dedicated to the respective data communication cards MO1 to MOn. This structure enables the respective terminals STA1 and STA2 to achieve wireless LAN communication with each other in an infrastructure mode via the router 20 and have access to the Internet INT. The router 20 has only to be connected communicably via the respective data communication cards MO1 to MOn to any external network, that is, it may be connected with a WAN (Wide Area Network) in place of the Internet INT.

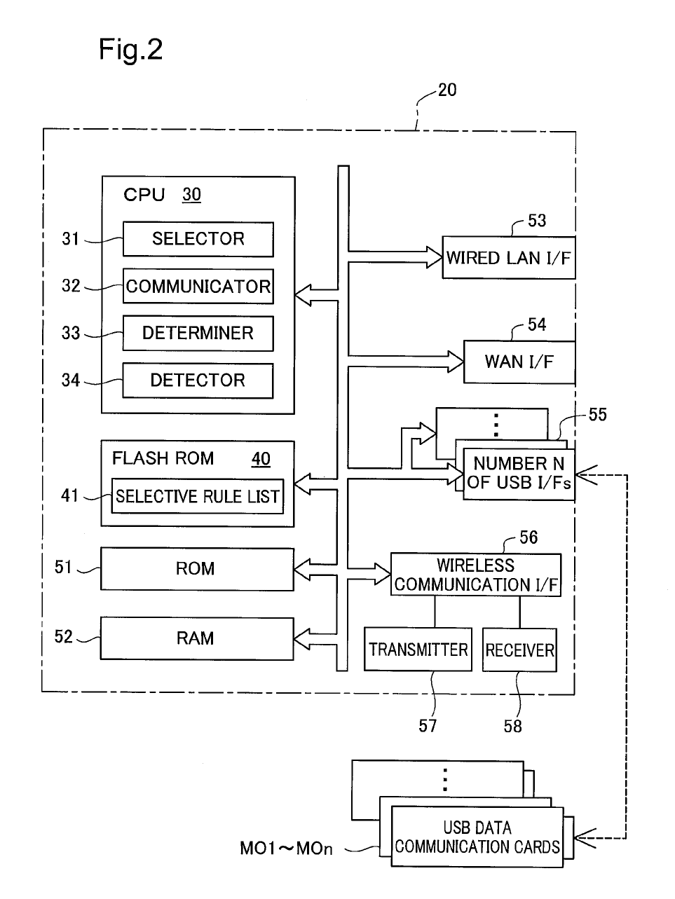

The general structure of the router 20 is shown in FIG. 2. As illustrated, the router 20 includes a CPU 30, a flash ROM 40, a ROM 51, a RAM 52, a wired LAN interface 53, a WAN interface 54, N USB interfaces 55, and a wireless communication interface 56, all of which are interconnected by a bus.

The CPU 30 loads programs, such as firmware, which are stored in the flash ROM 40 or in the ROM 51, on the RAM 52 and executes them to control the overall operations of the router 20. The CPU 30 executes the programs to function as a selector 31, a communicator 32, a determiner 33, and a detector 34. The details of these functional blocks will be described later.

The flash ROM 40 stores a selective rule list 41 therein. The selective rule list 41 has the record of one or more communication conditions adoptable for transferring to the Internet INT the packet sent from the terminal STA1 or STA2 to the Internet INT and received by the router 20.

The communication conditions specify which of the data communication cards receives the packet from the router 20, namely, which carrier is selected for the transmission of the packet. In this embodiment, communication conditions are recorded in the form of the selective rule list 41. Although these communication conditions may have various contents, it is assumed in the following description that three rules R1 to R3 are recorded as the communication conditions (described later in detail). However, the number of communication conditions is not restricted to three but may be any other desired number, for example, even only one.

The WAN interface 54 works to make connection with the external network, such as the Internet INT, by a fixed line. Although the WAN interface 54 is not used in the application example shown in FIG. 1, the router 20 may be connected to the Internet INT via the WAN interface 54.

Each of the USB interfaces 55 is a host-side USB connector that is connectable with various types of USB devices. Here the USB interface 55 of this embodiment is equivalent to the connector in the claims of the invention. As shown in FIG. 2, N data communication cards MO1˜MOn each having a USB connector are connected respectively with the N USB interfaces 55. The number of the data communication cards to be connected should be not less than two. In this embodiment, such connection information as, for example, the names of carriers, telephone numbers, APNs (access point names), user names, and passwords corresponding to the data communication cards MO1 to MOn, are registered in the router 20 through the user's operations of the terminal STA1 or STA2 via the WEB browser. This stage means the completion of connection setting. In fact, the respective data communication cards MO1 to MOn are ready for communication via the base stations BS1 to BSn. The wireless communication interface 56 is connected with a transmitter 57 for sending radio waves and with a receiver 58 for receiving radio waves. The transmitter 57 and the receiver 58 are built in the router 20 to allow for the transmission and the reception of radio waves, respectively.

### A-2. Connection Selection Process

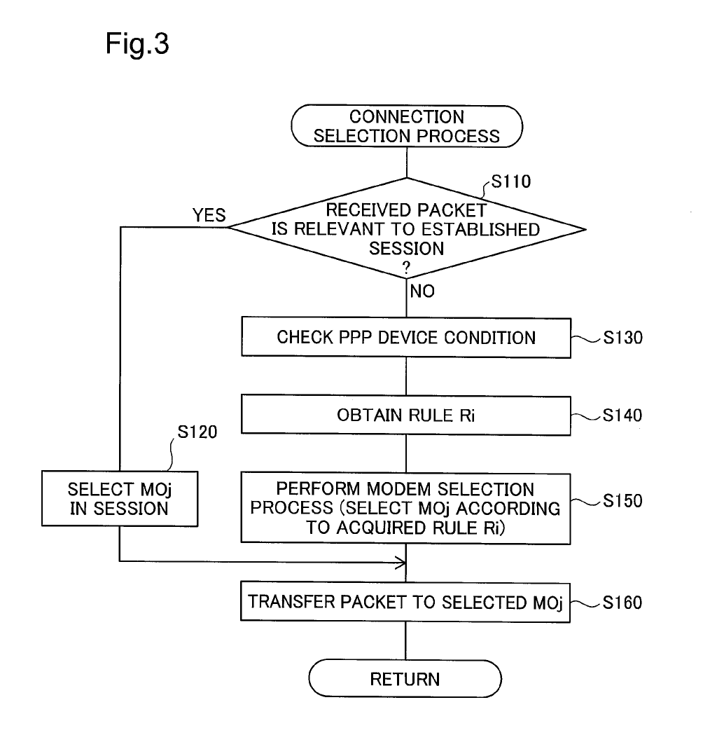

A connection selection process performed in the router 20 is described below with reference to the flowchart of FIG. 3. The connection selection process of the embodiment causes the router 20 to select a data communication card used for accessing the Internet INT from among the data communication cards MO1 to MOn. In this embodiment, the connection selection process is started when the router 20 receives a packet that has been sent from the terminal STA1 or STA2 to the Internet INT, and is repeated every time the router 20 receives a new packet. In FIG. 3, at the start of the connection selection process, the CPU 30 of the router 20 first judges whether the received packet is relevant to the already established communication session, for example, the TCP session (step S110). The judgment of whether or not the received packet is relevant to the established communication session, can be passed by referring to the SYN flag included in the TCP header.

If the received packet is relevant to the established TCP session (step S110: Yes), the CPU 30 selects the session-established data communication card MOj, (j denotes an integer between 1 and N, including both ends) (step S120). If the received packet is not relevant to the established TCP session (step S110: No), on the other hand, the CPU 30 checks the PPP (Point-to-Point Protocol) device condition (step S130). This step S130 checks a PPP session with the corresponding ISP (Internet Service Provider) with regard to each of the data communication cards MO1 to MOn and selects one of the data communication cards which is ready for connection from among all the data communication cards MO1 to MOn. When the check result shows an unconnected state, connection and authentication are repeated a preset number of times. In this embodiment, it is assumed that all the data communication cards MO1 to MOn are ready for communication.

After checking the PPP device condition, the CPU 30 obtains rule Ri selected from among the rules R1 through R3 recorded in the selective rule list 41, where ‘i’ denotes an integer of 1, 2, or 3 (step S140).

In this embodiment, the rules R1 through R3 can be selected by the user. Therefore, the user selects in advance a desired rule R1 through the user's operations of an UI (User Interface) provided in the router 20 or the user's operations of the terminal STA1 or STA2 via the Web browser so that the selected rule R1 is stored in the flash ROM 40. The CPU 30 then reads the information in the flash ROM 40 to obtain the rule R1 at step S140.

After obtaining the rule R1, the CPU 30 causes the selector 31 provided therein to perform a modem selection process (step S150). The modem selection process selects, in accordance with the acquired Rule R1, one data communication card MOj (j is an integer between 1 and N, including both ends) from among the data communication cards MO1 to MOn that have been determined to be in the connectable state at step S130. The rule Ri which can be selected in this embodiment is one of the rules R1 to R3. Their characteristics are as follows. Concrete procedures of selecting the data communication card MOj according to the respective rules R1 to R3 will be described later.

(1) Rule R1: the condition of selecting the data communication cards MO1 to MOn so as to distribute the communication load to the respective data communication cards MO1 to MOn;

(2) Rule R2: the condition of selecting the data communication cards MO1 to MOn on the basis of the rule defined in compliance with various pieces of information included in a packet sent to the Internet INT; and

(3) Rule R3: the condition of selecting one of the data communication cards MO1 to MOn that receives the radio wave of which the field intensity is relatively stronger among the radio waves transmitted from the respective base stations BS1 to BSn.

After selecting the data communication card MOj, the CPU 30 causes the communicator 32 provided therein to transfer the received packet to the selected data communication card MOj (step S160). The connection selection process terminates in this way. Subsequently, a TCP session is established between the terminal STA1 or STA2 and a server or a terminal on the Internet INT so that a predetermined communication is performed via the selected data communication card MOj.

For actual communication, the router 20 of the above-described configuration selects one of the data communication cards MO1 to MOn that are connected in a communicable manner and have different communication characteristics, on the basis of one of the Rules R1 R3 corresponding to preset communication conditions, and performs communication with the Internet INT by a new TCP session. Accordingly, wireless communication can be carried out by automatically selecting the data communication cards MO1˜Mon having different communication characteristics, as the situation requires, on the basis of the predetermined communication conditions. As a result, the user is not required to select one of the data communication cards MO1 to MOn each time wireless communication is to be performed. This design effectively enhances usability. Moreover, since the data communication cards MO0˜MOn to be used can be automatically selected, they can be changed over frequently so that communication in response to time-varying communication conditions can be effectively performed.

The concrete procedures of the modem selection process according to the respective rules R1 to R3 (step S150) are described below.

### A-2-1. Modem Selection Process According to Rule R1

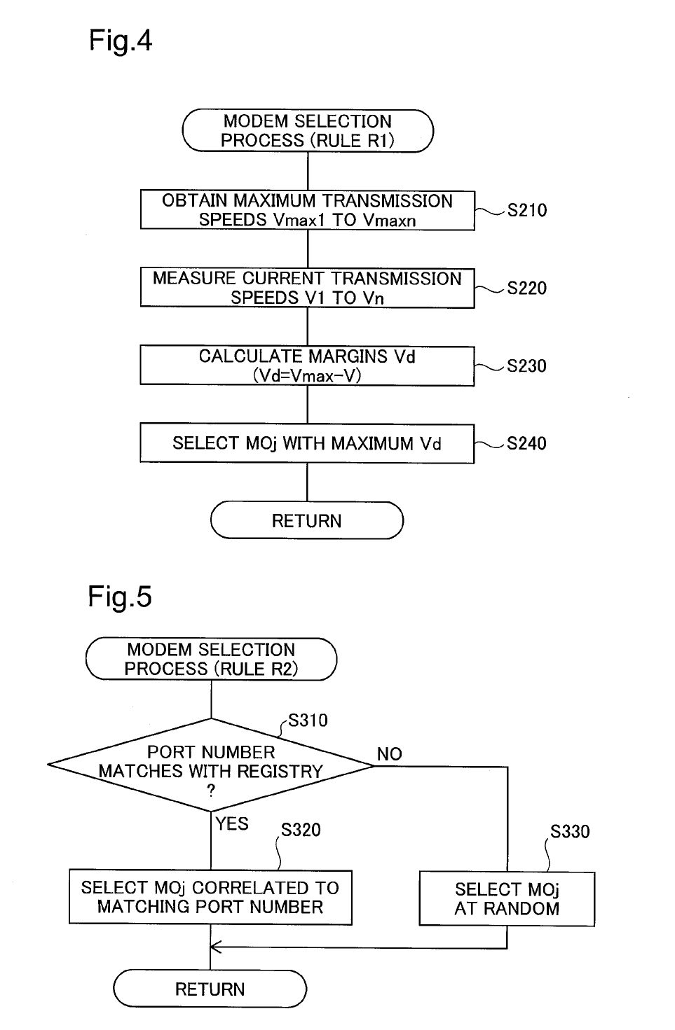

The flow of a modem selection process according to the rule R1 is shown in FIG. 4. As explained above, the rule R1 is the condition of selecting one of the data communication cards MO1 to MOn to distribute the communication load to the respective data communication cards MO1 to MOn. When this flow is initiated, the CPU 30 first obtains the maximum transmission speeds Vmax1 to Vmaxn associated with the respective data communication cards MO1 to MOn (step S210). The maximum transmission speeds Vmax1 to Vmaxn represent the maximum throughputs per unit time of the respective data communication cards MO1 to MOn. In the description below, the maximum transmission speeds Vmax1 to Vmaxn of the respective data communication cards MO1 to MOn are collectively referred to as the maximum transmission speed Vmax or maximum transmission speeds Vmax. In this embodiment, the CPU 30 measures the inbound throughput and the outbound throughput of each of the data communication cards MO1 to MOn at a preset timing, e.g. once for the preset time period T1 (e.g., T1=1 hour), and records the average value of the measured inbound throughput and outbound throughput, in the RAM 52. The maximum of the recorded averages with respect to the data communication cards MO1˜MOn, for the predetermined period 2T (2T=3 hours in this case) is considered the maximum transmission speed Vmax. In fact, Vmax is the maximum of the throughputs obtained in the last three measurements.

To be concrete, the outbound throughput is obtained as the result of measuring the transmission of dummy data having a sufficient size (e.g. 2 mega bytes) in a test mode to the URL (Uniform Resource Locator) of a predetermined destination (e.g. server on the Internet INT provided by a manufacturer of the router 20). The throughput is measured by counting the number of packets sent within a predetermined time period in this embodiment, but may alternatively be calculated from the decreasing amount of content of the transmission buffer per unit time. The inbound throughput is obtained as the result of measuring the time required for receiving the response to the HTTP whose entity size is known, after a dummy HTTP has been transmitted in a test mode to the URL of predetermined destination.

It should be noted here that the maximum transmission speeds Vmax need not be necessarily measured in the test mode. For example, when the amount of packet data accumulated in the buffer reserved in the RAM 52 at the time of the measurement of throughput exceeds a predetermined amount, it is determined that the wireless channel corresponding to a certain data communication card is used with the maximum channel load. Then, the transmission or reception in the test mode is omitted and the throughput at the time of omission in the test mode may be measured. With this design, the loads on the respective data communication cards Mo1 to MOn and on the channels can be reduced.

After obtaining the maximum transmission speeds Vmax in this way, the CPU 30 subsequently measures the current transmission speeds V1 to Vn (step S220). The current transmission speeds V1 to Vn represent the current throughputs of the respective data communication cards MO1 to MOn. In the description below, the current transmission speeds V1 to Vn of the respective data communication cards MO1 to MOn are collectively referred to as the transmission speed V or transmission speeds V. In this embodiment, as with the maximum transmission speed Vmax, the transmission speed V is given as the average value of outbound and inbound throughputs.

After measuring the transmission speeds V, the CPU 30 causes the determiner 33 to calculate margins Vd1 to Vdn with respect to the data communication cards MO1 to MOn according to Expression (1) given below (step S230):

Vd=Vmax−V (1)

In the description below, the margins Vd1 to Vdn of the respective data communication cards MO1 to MOn are collectively referred to as the margin Vd or margins Vd.

As clearly understood from Expression (1) given above, the margin Vd represents the difference between the maximum transmission speed Vmax and the transmission speed V in this embodiment. The communication speeds of the data communication cards MO1 to MOn vary every second, depending on various factors, such as the congestion of radio channels and the routed paths of packets. There is a possibility of increasing the throughput up to the last maximum transmission speed Vmax, if the congestions of radio channels and the routed paths of packets change. This means that there is still be a margin for the communication load. Therefore, the difference between the maximum transmission speed Vmax and the transmission speed V is regarded as the margin of the communication load of each data communication card. The margin Vd is not restricted to the difference between the maximum transmission speed Vmax and the transmission speed V but may be any other suitable value representing the degree of deviation of the transmission speed V from the maximum transmission speed Vmax, such as, for example, a ratio of the transmission speed V to the maximum transmission speed Vmax.

If the margins Vd is calculated in this way, the CPU 30 selects the data communication card having the largest margin among the calculated margins Vd as the data communication card MOj (step S240).

As described above, by selecting data communication card MOj according to the rule R1, the router 20 can determine the status of communication load distributed to the data communication cards MO1 to MOn and select the data communication cards MO1 to MOn in such an order as to distribute the communication load to them. Consequently, the data communication cards MO1 to MOn can be selected in such a manner that the overall communication speed of the router 20 can be increased. Further, since the router 20 calculates the margin Vd from the maximum transmission speed Vmax in the preset time period and the current transmission speed V with regard to each of the data communication cards MO1 to Mon, the status of communication load can be properly determined even when the respective data communication cards MO1 to MOn have different communication characteristics.

In the modem selection process described above, although the maximum transmission speed Vmax and the transmission speed V are calculated by using the average values of the outbound and inbound throughputs, they need not necessarily resort to using the average values but may be obtained by employing the weighted average which is obtained by multiplying the outbound and inbound throughputs by preselected weighting factors and then striking the average of the sum of the weighted throughputs. It is a matter of course that the maximum transmission speed Vmax or the transmission speed V may be obtained by using outbound throughputs alone or inbound throughputs alone. Furthermore, the degree of the contribution of the outbound and inbound throughputs to the process of obtaining the maximum transmission speed Vmax or the transmission speed V, may be adjusted in accordance with the information included in the packet received from the terminal STA1 or STA2. For example, when a packet received by the router 20 is an HTTP request, there is a high probability of downloading data. A relatively larger weighting factor may thus be applied to the outbound throughput. On the other hand, when the received packet is relevant to electronic mail, the source port number included in the packet at the sending time is different from the source port number at the receiving time. The weighting factors of the upstream throughput and the downstream throughput may thus be varied according to the port numbers. To be more concrete, only the outbound throughput may be used at the sending time, while only the inbound throughput may be used at the receiving time. This design can determine the status of communication load corresponding to the actual communication direction, i.e. outbound or inbound, thereby enhancing the accuracy of the determination.

In the modem selection process described above, the maximum transmission speed Vmax is calculated from the latest three measurements of throughputs. However, the measurements as the basis of the calculation of the maximum transmission speed Vmax may be made any number of times. The frequency and the timing of measurements should be properly determined to keep a good balance between the adoption of the latest possible communication status and the network load.

### A-2-2. Modem Selection Process According to Rule R2

The flow of the modem selection process according to the rule R2 is shown in FIG. 5. As explained above, the rule R2 is the condition of selecting the data communication cards MO1 to MOn under the rule defined according to various pieces of information included in packets sent to the Internet INT. The rule R2 is that which the user or the manufacturer prepares in advance as a selective rule list 41 by relating various data contained in packets, such as, for example, data representing predetermined communication sources and destinations, and port numbers to the data communication card to be selected for the communication of those packets, or relating the various data to the selective rules to be used for the communication of those data. For example, when users play an online game via the Internet INT by using the terminals STA1 and STA2, the quick response is required for the users to satisfactorily enjoy the online game. For example, a response speed of 50 msec or shorter is generally required in shooting games. Therefore, in the case where such a well-known data communication card having a high response speed, such as, for example, a PHS system data communication card, is used, a data communication card, selected from among the cards MO1˜Mon, suitable for such an online game can be selected by previously relating the port number associated with online games to the data which specifies the data communication card having an excellent response speed (e.g. MAC address).

To be concrete, when the modem selection process shown in FIG. 5 is initiated, the CPU 30 first refers to the header information included in the received packet and checks whether the source port number included in the received packet matches that registered in the selective rule list 41 (step S310). Consequently, if the checked source port number matches the registered one (step S310: Yes), the CPU 30 selects the data communication card MOj related to the matched port number in the selective rule list 41 (step S320). On the other hand, if the checked source port number does not match the registered one (step S310: No), the CPU 30 selects data communication cards MOj at random (step S330).

As described above, the router 20 which selects the data communication card MOj according to the rule R2, can select any one of the data communication cards MO1˜MOn that corresponds to a desired communication condition with respect to one of the communication natures derived from various data included in packets. This process is very simple since it is only required to select the data communication card MOj related to a certain piece of information included in a received packet.

In the embodiment described above, the data communication cards MOj are selected based on the port numbers included in the received packets. Alternatively, however, the data communication cards MOj may be selected on the basis of the data representing communication sources by previously registering in the selective rule list 41 the relationships between the data representing communication sources such as, for example, MAC addresses and the data communication cards MOj to be selected. For this modified design can also enjoy the same advantage in the case where t the application of the terminal STA1 or STA2 is limited only to a specific purpose, for example, to the use for games alone. Furthermore, the data communication cards MOj may be selected on the basis of the data representing communication destinations by previously registering in the selective rule list 41 the relationships between the data representing communication destinations such as, for example, URLs and the data communication cards MOj to be selected. For this design can also enjoy the same advantage since in case of playing an online game, access is made to the server having the particular URL corresponding to the online game. It is to be noted here that although packets received from and sent to the server to be accessed do not include URL information, it is easy to specify the URLs registered in the selective rule list 41 on the basis of the destination IP addresses contained in the packets if a routing table that relates URLs to IP addresses is formed in the router 20 by the help of the D N S (Domain Name System).

In the embodiment described above, the selective rule list 41 is previously prepared in which the various data contained in packets, such as data representing specific communication sources and destinations, and port numbers, are related respectively to the data communication cards to be selected in communication of the packets. Alternatively, however, the selective rule list 41 may be replaced by a list in which those various data are related to selection criteria adopted when such data are included in the packets. For example, the following procedure may be employed: a specific port number is related to a selection criterion that a data communication card having the fastest response is selected from among the data communication cards MO1 to Mon; the RTTs (Round Trip Times) for the data communication cards MO1 to Mon are detected by using ping commands in the step S320 described above whenever packets are received; and the data communication card MOj associated with the minimum RTT is selected. This procedure enables a data communication card suitable for online games to be selected from among the data communication cards MO1 to MOn with high accuracy.

Another procedure may also be employed as follows: a specific port number is related to a selection criterion that the data communication cards MO1˜Mon are selected in such a manner that the communication load is distributed; and a particular data communication card MOj is selected in the step S320 described above in accordance with the rule R1 whenever packets are received. In such a case, the specific port number may be related to such a protocol as FTP (File Transfer Protocol) or RTSP (Real Time Streaming Protocol), which is expected to handle a large amount of data. By doing so, the communication load can be distributed among the data communication cards. In still another example, the port number corresponding to the protocol expected to handle a large quantity of data may be related to the data communication card under contract with a charge system of flat rate.

### A-2-3. Modem Selection Process According to Rule R3

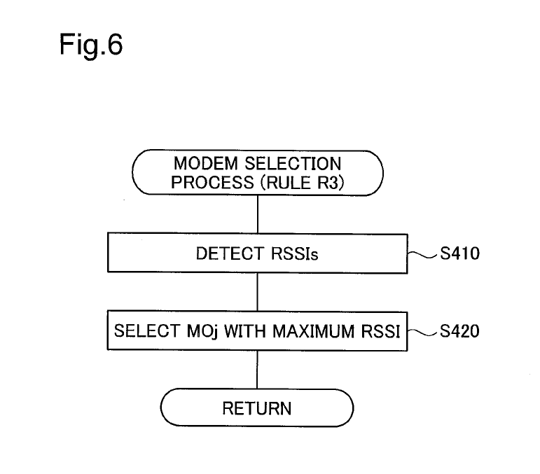

The flow of the modem selection process according to the rule R3 is shown in FIG. 6. As explained above, the rule R3 is the condition of selecting one of the data communication cards MO1 to MOn which receives radio waves having a relatively high field intensity, from the respective base stations BS1 to BSn. When this process is initiated, the CPU 30 activates the detector 34 to cause the RSSI (Received Signal Strength Indicator) detection circuit equipped in the wireless communication interface 56 to detect the RSSIs representing the field intensities of the radio waves transmitted by the base stations STA1 and STA2 and received through the data communication cards MO1 to MOn (step S410). After the detection of the RSSIs, the CPU 30 selects that data communication card MOj which receives the maximum RSSI, from among the data communication cards

As described above, since the router 20 designed to select the data communication card MOj according to the rule R3 can automatically select that modem which receives a relatively strong RSSI from among the RSSIs of radio waves transmitted from the respective base stations BS1 to BSn, the data communication card MOj can be so selected as to assure stable communication.

### B. Second Embodiment

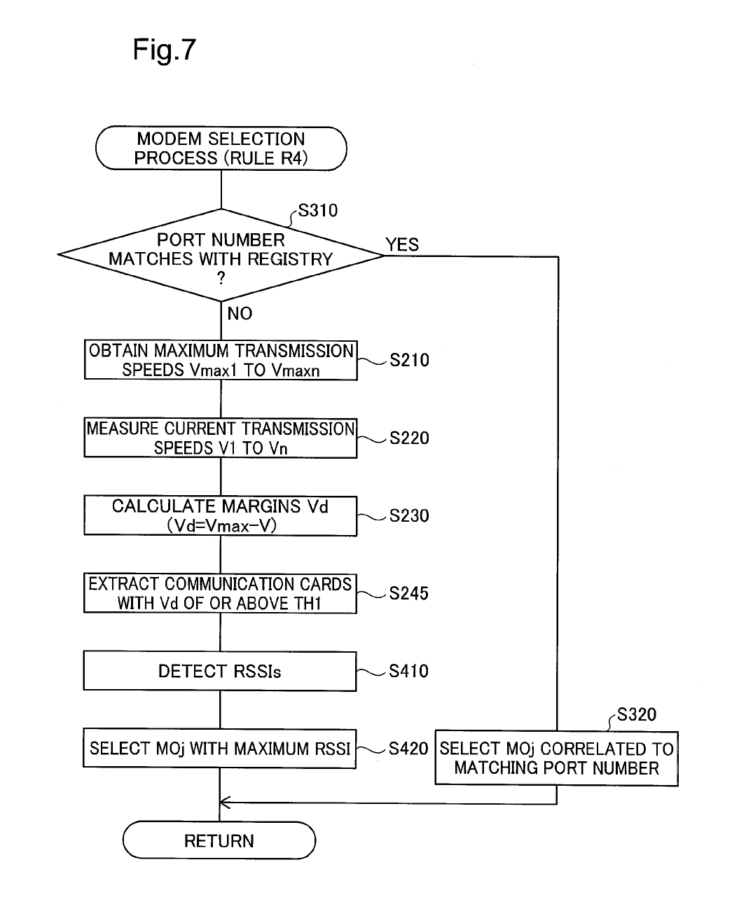

In the following is described a second embodiment according to the present invention. The router 20 of the second embodiment has substantially the same structure as that of the first embodiment. Only the differences of the router 20 of the second embodiment from that of the first embodiment are the communication condition used in the modem selection process and the flow of the modem selection process involving the difference in the communication condition. In other words, the rule R4, which is the communication condition according to the second embodiment, is different from the first embodiment in that it consists of the rules R1˜R3 in combination. The flow of the modem selection process as the second embodiment is shown in FIG. 7. In the description below, explanation of the steps substantially common to the first embodiment and the second embodiment will be omitted or simplified. The steps of FIG. 7 substantially similar to those of the first embodiment are indicated by the identical step numbers.

As shown in FIG. 7, when the modem selection process of the second embodiment is initiated, the CPU 30 first checks whether the source port number included in the received packet matches any one of the source port numbers registered in the selective rule list 41 (step S310). As a result, if there is a coincidence between the received source port number and one of the registered source port number (Step 310: YES), the CPU 30 selects the data communication card MOj related to the port number found in the selective rule list 41 (step S320). On the other hand, if the received source port number does not coincide with any of the registered source port numbers (step S310: No), the CPU 30 obtains the maximum transmission speeds Vmax (step S210), measures the transmission speeds V (step S220), and calculates the margins Vd (step S230). Then, the CPU 30 extracts those of the data communication cards MO1˜Mon which have the calculated margins Vd that are not less than a preset value TH1 (step S245). After the extraction of the demanded data communication cards, the CPU 30 detects the RSSIs of the extracted data communication cards (step S410) and selects that data communication card MOj from among the extracted data communication cards which has the maximum RSSI (step S420).

As clearly understood from the above explanation, the communication condition used in the modem selection process may consist of two or more conditions in combination. This design assures the flexible selection of the data communication card MOj suitable for the situation, thus enhancing the user's convenience.

### C. Third Embodiment

A third embodiment according to the present invention will now be described. The router 20 of the third embodiment has the same structure as that of the first embodiment. Only the difference of the router 20 of the third embodiment from that of the first embodiment is that the former performs the process of changing connection destinations. The process of changing connection destination is the process in which if the communication traffic can be expected with respect to the Internet INT in a session after packets have been sent toward the Internet INT as a result of performing this very process, the data communication cards MO1˜MOn are reselected in accordance with the communication traffic. The process of changing connection destination will be described below.

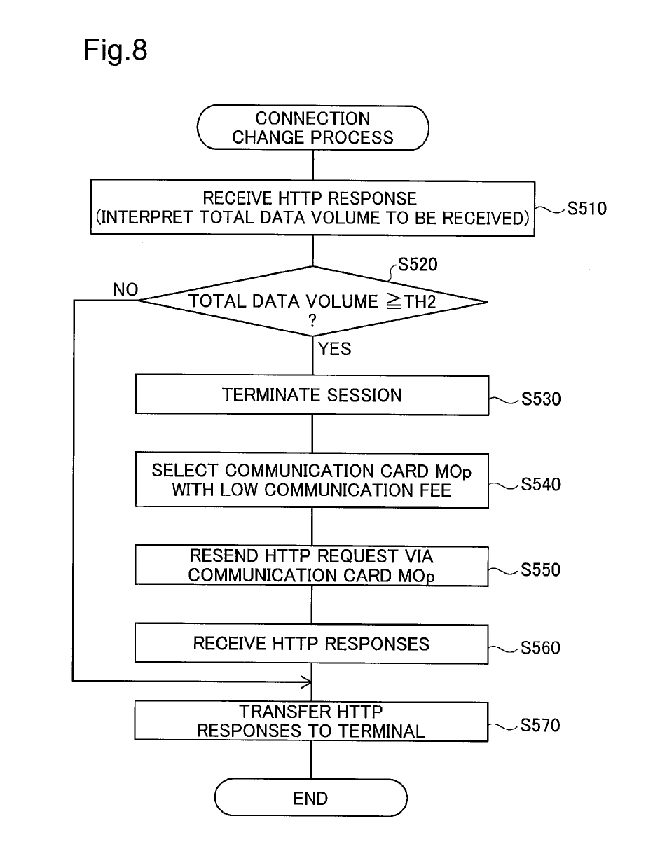

The flow of the connection destination change process is shown in FIG. 8. In this embodiment, the connection destination change process is started when a HTTP demand is sent to the Internet INT via the data communication card under contract with the charge system of metered rate in the connection selection process described above. It is to be noted here that whether or not the charge system is of metered rate may be based on the information which the user previously registered in the router 20. When this process is initiated, the CPU 30 receives one of the HTTP responses and figures out the total data volume of the HTTP responses expected to be received hereafter (step S510). The total data volume is written in the entity header field of the received HTTP response.

After figuring out the total data volume, the CPU 30 checks whether the figured-out total data volume is equal to or greater than a preset value TH2 (step S520). Consequently, if the total data volume is less than the preset value TH2 (step S520: No), the CPU 30 transfers the received HTTP response to the terminal STA1 or STA2 that has sent the HTTP request (step S570). In this case, therefore, the connection destination change does not take place.

On the other hand, if the total data volume is equal to or greater than the preset value TH2 (step S520: Yes), the CPU 30 terminates the established TCP session (step S530) and selects that data communication card MOp through which the communication fee is low (step S540). The data communication card MOp through which the communication fee is low, means a data communication card which is under contract with a charge system of flat rate or a data communication card with a charge system of relatively low metered rate. In this embodiment, the CPU 30 selects the data communication card MOp, which the user registered in advance in the router 20. However, in the case where carrier service sets the fees of communication with specific destinations low or fixed, the data communication card Mop may be selected in consideration of such a case. Moreover, in the case where the user registers in advance the method of calculating the communication fee, the router 20 may calculate the communication fee for the total volume of received data and select a data communication card MOp through which communication fee is relatively low. The selection of such a data communication card Mop can, of course, be based on a criterion involving the rules R1 through R3 described above with the first embodiment.

After the selection of the data communication card MOp, the CPU 30 resends the HTTP request associated with the terminated TCP session via the selected data communication card MOp (step S550). In this embodiment, the router 20 is designed to store the HTTP request received from the terminal STA1 or STA2 in the RAM 52 and is thus allowed to resend the HTTP request. After resending the HTTP request, the CPU 30 receives an HTTP response as a reply to the resent HTTP request (step S560) and sequentially transfers the successively received HTTP responses to the terminal STA1 or STA2 that has sent the corresponding HTTP requests (step S570). Thereafter, the connection destination change process terminates.

The router 20 of this design reselects the data communication cards MO by changing the communication conditions according to the expected traffic of communication with the Internet INT in one TCP session, and therefore the router 20 can flexibly switch over the data communication cards MO in accordance with the amount of the interested communication so that the router 20 can perform communication adapted to the communication traffic. Hence, usability is improved.

The above-described communication condition can be changed in various ways. For example, when the communication traffic is equal to or higher than a predetermined level, the communication condition may be changed from the rule R1 to the rule R2 or vice versa. The communication traffic equal to or higher than the predetermined level is considered heavy communication load and requires a long time period for transmission. Accordingly, when importance is put on the distribution of communication load, the communication condition should be changed to the rule R1. When importance is set on the stability of communication, the communication condition should be changed to the rule R2. Alternatively, when the communication traffic is lower than the predetermined level, the communication condition may be changed to reselect another data communication card. For example, if the communication traffic is at a low level, it has little effect on the distribution of load. Therefore, importance is put on the stability of communication, and the communication condition may be changed from the rule R1 to the rule R3.

### D. Modifications

Some modifications of the above embodiment are described below.

### D-1. Modification 1

The router 20 of the above embodiment is configured to select a data communication card satisfying a specified communication condition. The communication condition may include an exclusion criterion. For example, a data communication card under contract with a charge system of metered rate may be selected only when a packet including a specified port number is received. But, the data communication card may be excluded from options when the received packet does not include the specified port number. With this configuration, if there exists a port number which is not available under contract with a charge system of flat rate but is available under contract with a charge system of metered rate, communication fee can be suppressed while necessary communication functions are retained. Addition of such an exclusion criterion to the communication condition allows for the more flexible selection of data communication cards according to the usage, thus enhancing the convenience.

### D-2. Modification 2

In the embodiment described above, each of the data communication cards MO1 to MOn connected to the USB interface 55 is integrated with a USB connector. Alternatively, each data communication card without a USB connector may be combined with an adapter equipped with a USB connector to be connected to the USB interface 55. The interface connected with the data communication card is not specifically restricted to those described above, but may have, for example, a slot capable of receiving, for example, a PCI ExpressCard (registered trademark) therein. It is needless to say that wireless communication means need not be in the form of a data communication card, but take a form of a device connected with a portable telephone set via a modem cable, or a wireless communication module incorporated in the router 20.

### D-3. Modification 3

In the above embodiment, the communication apparatus according to the invention is disclosed as the router 20. The communication apparatus may be realized in the form of a variety of electronic devices that can perform communication by connecting therewith means for wireless communication, such as data communication cards, personal computers and PDAs (Personal Digital Assistants).

The embodiment of the invention and its modifications are described above. Among the various constituents and components included in the embodiment of the invention discussed above, those other than the constituents and components included in independent claims are additional and supplementary elements and may be omitted or combined according to the requirements. The embodiment and its modifications discussed above are to be considered in all aspects as illustrative and not restrictive. There may be many other modifications, changes, and alterations without departing from the scope or spirit of the main characteristics of the present invention. The invention is not only applied to the communication apparatus discussed above, but also to a communication method, a communication program product and a storage medium for storing the communication program product.

What is claimed is:

1. A communication apparatus, comprising:
a connector arranged and adapted to be connectable with modems that have different communication-related characteristics and achieve wireless communication with an external network;
a selector arranged and adapted to select one of the modems that are connected with the connector in a communicable manner, in accordance with a preset communication condition, for communication with the external network in a new session; and
a communicator arranged and adapted to achieve wireless communication with the external network in the new session by using the selected modem.

2. The communication apparatus in accordance with claim 1, wherein the preset communication condition includes a condition of selecting the modem under a rule defined in accordance with a data contained in a packet which the communicator transmits to the external network.

3. The communication apparatus in accordance with claim 1, further comprising:
a determiner arranged and adapted to determine a status of communication load on each of the modems,
wherein the preset communication condition includes a condition of selecting the modems in such a manner that the communication load is distributed to the modems.

4. The communication apparatus in accordance with claim 3, wherein the determiner obtains an outbound speed and an inbound speed at which the communicator communicates with the external network, and determines a status of the communication load based on at least one of the obtained outbound and inbound speed; and
the determiner varies a degree of contribution of the outbound and inbound speeds to the determination of the status of the communication load according to data included in a packet with which communication with the external network is performed.

5. The communication apparatus in accordance with claim 1, further comprising:
a detector arranged and adapted to detect a field intensity of radio wave transmitted from a base station of a carrier corresponding to each of the modems,
wherein the preset communication condition includes a condition of selecting one modem receiving a radio wave having a relatively high field intensity from among the modems.

6. The communication apparatus in accordance with claim 1, wherein the preset communication condition is one communication condition selected from among at least two different communication conditions, and
when expected communication traffic to or from the external network in one session is figured out, the selector changes the communication condition according to the expected communication traffic and reselect another modem from among the modems.

7. A communication method of causing a communication apparatus to achieve communication with an external network, wherein the communication apparatus is connected with plural modems that have different communication characteristics and are ready for communication with the external network, the communication method comprising:
selecting one modem out of the connected modems, based on a preset communication condition, for achieving communication with the external network in a new session; and
using the selected modem and achieving communication with the external network in the new session.

8. A computer program product comprising a computer-readable medium having computer program logic stored therein to enable a computer to achieve communication between a communication apparatus and an external network, wherein the communication apparatus is connected with plural modems that have different communication characteristics and are ready for communication with the external network,
the computer program logic comprising:
a program code for selecting one modem out of the connected modems, based on a preset communication condition, for achieving communication with the external network in a new session; and
a program code for using the selected modem and achieving communication with the external network in the new session.
